(19) United States
(12) Patent Application Publication
(10) Pub. No.: US 2018/0318946 A1
(43) Pub. Date: Nov. 8, 2018

(54) DEVICE AND METHOD FOR FINISH MACHINING OF GEARWHEEL WORKPIECES

(71) Applicant: Klingelnberg AG, Zürich (CH)

(72) Inventors: Jürgen Gsell, Remscheid (DE); Hartmuth Müller, Remscheid (DE)

(21) Appl. No.: 15/969,008

(22) Filed: May 2, 2018

(30) Foreign Application Priority Data
May 4, 2017 (EP) 17169393.0

(51) Int. Cl. B23F 19/00; B23F 23/12

(52) U.S. Cl. CPC B23F 19/005; B23F 23/1218

(57) ABSTRACT

A machine tool (20) for machining a gearwheel workpiece (1), having: a tool spindle (21) for fastening a tool (2), a workpiece spindle (22) for fastening the gearwheel workpiece (1), a CNC controller (50) and multiple axes for the CNC-controlled machining of the gearwheel workpiece (1) using the tool (2), an optical detector (40) to acquire image information (BI) of the gearwheel workpiece (1), and a module (51), which is designed to ascertain characteristic actual parameters of the gearwheel workpiece (1) based on the image information (BI) of the gearwheel workpiece (1).

### CROSS-REFERENCE TO RELATED APPLICATIONS

This application claims the benefit under 35 U.S.C. § 119(e) to European Application no. EP 17 169 393.0 filed May 4, 2017, which is hereby expressly incorporated by reference as part of the present disclosure.

### FIELD OF INVENTION

The present disclosure generally relates to devices and methods for finish machining of gearwheel workpieces using a tool.

### BACKGROUND

Subjecting gearwheel workpieces to finish machining in order to correct manufacturing-related deviations, or to reduce hardening distortions, which result during the hardening of a previously cut (toothed) gearwheel workpiece, is known.

This finish machining frequently takes place using a CNC-controlled machine tool, which comprises a sensor for the tactile scanning of the gearwheel workpiece. After the scanning has been performed, the finish machining can take place using this machine.

It is a disadvantage of this approach that the tactile scanning is slow. To find a compromise between the informative value of the information ascertained by scanning and the throughput of the machine tool, the scanning is restricted to only three tooth flanks, for example. The finish machining is then performed based on the information thus obtained.

It is a further disadvantage of the use of a tactile sensor that it is sensitive and therefore has to be infed cautiously.

### SUMMARY

It is therefore an object to provide an approach to acquire as much information as possible as rapidly as possible about a gearwheel workpiece in a machine tool.

Disclosure herein is directed to an optical detector as a sensor for this purpose, wherein this detector is arranged in the machine tool such that it can acquire all essential details of the gearwheel workpiece in one pass. Alternatively, if the detector does not have a correspondingly large imaging region, a relative movement of the detector in relation to the gearwheel workpiece is used to acquire all essential details.

To make the image information which is provided by the detector technically usable, this image information is subjected to an ascertainment method. In the scope of this ascertainment method, characteristic actual parameters of the gearwheel workpiece are ascertained based on the image information.

Then a machining method of at least one flank of the gearwheel workpiece is carried out in the machine tool using the tool, wherein at least one characteristic actual variable or parameter is used in order to move the tool by way of a relative movement without collision into a tooth gap of the gearwheel workpiece, the flank of which is to be subjected to the machining method.

The gearwheel workpiece is not re-chucked between acquiring the image information and carrying out the machining method. This means the gearwheel workpiece remains in the machine tool in some embodiments, to thus maintain the spatial association between the gearwheel workpiece and the machine tool.

Further advantageous embodiments are disclosed herein.

It is an advantage of various embodiments that both the optical measurement and also the finish machining take place in one machine tool without re-chucking the gearwheel workpiece. It can thus be ensured that optically ascertained characteristic actual parameters of the gearwheel workpiece can be used, in order to be able to introduce a tool into a tooth gap without collision in relation to the gearwheel workpiece.

It is another advantage that very short checking times are sufficient to plan the subsequent steps of the finish machining. Optical methods disclosed herein are significantly faster than methods which operate using tactile sensors. Moreover, using an optical detector, an entire gearwheel workpiece can be acquired using one or only a few recordings (pictures). In the case of tactile methods, sometimes only three tooth flanks are scanned to compute corrections based on this information.

The methods disclosed herein can be used, for example,

for indexing checking/indexing measurement and correction,

for checking and for correcting concentricity errors,

for rapidly finding a tooth gap and/or a tooth head,

for centering the tool in relation to a tooth gap,

for finish machining/fine machining of hardened gearwheel workpieces,

for planning method-optimized finish machining of hardened gearwheel workpieces.

Embodiments of the invention herein offer the advantage that in the case of hardened gearwheel workpieces, the finish machining can be planned and carried out so that the hardened layer on the tooth flanks of the gearwheel workpiece is not removed.

According to one aspect, a method for machining a toothed gearwheel workpiece using a machine tool with a sensor to acquire geometry information, a tool on a tool spindle, and a gearwheel workpiece on a workpiece spindle includes a) acquiring image information of the gearwheel workpiece with the sensor of an optical detector, b) ascertaining at least one characteristic actual parameter of the gearwheel workpiece based on the image information, and c) machining at least one flank of the gearwheel workpiece with the tool. The tool is moved into a tooth gap of the gearwheel workpiece using at least one characteristic actual parameter to machine at least one flank by relative movement of the tool and the gearwheel workpiece.

In some embodiments, the optical detector acquires image information of at least a part of the gearwheel workpiece. In some embodiments, relative movement is executed between the detector and the gearwheel workpieces to acquire image information of a region of the gearwheel workpiece larger than the imaging region of the detector. Some embodiments include (a) converting the image information into edge and/or surface specifications, and (b) ascertaining at least one characteristic actual parameter using the edge and/or surface specifications. Some embodiments include converting the image information into edge specifications using an algorithm adapted or configured to detect edges. Some embodiments include determining the position of at least one tooth head and/or tooth flank and/or tooth gap, where such position is used as a characteristic actual parameter or parameters. In some embodiments, the optical detector includes a CCD detector with a group of detector elements configured to acquire image information as pixels.

According to another aspect, a machine tool for machining a gearwheel workpiece includes: a tool spindle configured for fastening a tool thereto; a workpiece spindle configured for fastening a gearwheel workpiece thereto; and a CNC controller. The machine tool defines multiple axes, which are used in the CNC-controlled machining of the gearwheel workpiece with the tool. The machine tool has an optical detector to acquire image information of a gearwheel workpiece, and a module to ascertain at least one characteristic actual parameter of a gearwheel workpiece based on such image information.

In some embodiments, the machine tool is configured to execute a relative movement between the detector and the gearwheel workpiece while the detector acquires image information of the gearwheel workpiece. In some embodiments, the module is configured to acquire image information, and to ascertain at least one characteristic actual parameter from edge and/or surface specifications derived from such image information. In some embodiments, the module is configured to process image information for edge detection by using an algorithm. In some embodiments, the detector is a CCD detector having a group of detector elements that acquire image information as pixels.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features will become apparent from the following detailed description, which are to be understood not to be limiting and which will be described in greater detail hereafter with reference to the drawings, wherein:

FIG. 1 shows a schematic view of a section of a crown wheel workpiece;

FIG. 2A shows a schematic view of the image information of a detail al of FIG. 1, which was ascertained using an optical detector;

FIG. 2B shows a schematic view of data which was ascertained during an ascertainment method from the image information of the embodiment illustrated in FIG. 2A;

FIG. 2C shows a schematic view of edge information which was ascertained at the end of an ascertainment method from the image information of the embodiment illustrated in FIG. 2B;

FIG. 3A shows a simplified perspective view of an optical detector, which can be used in a machine tool;

FIG. 3B shows a schematic block diagram of the components of an optical detector of the embodiment illustrated in FIG. 3A;

FIG. 3C shows a schematic block diagram of the components of an exemplary module;

FIG. 4 shows a schematic view of a part of a machine tool, a grinding machine here, which is equipped with an optical detector;

FIG. 5A shows a schematic view of the image information of a detail al, wherein this image information was ascertained using the optical detector of the machine tool, as shown in the embodiment illustrated in FIG. 4;

FIG. 5B shows a schematic view of edge information which was ascertained at the end of an ascertainment method from the image information of the embodiment illustrated in FIG. 5A.

### DETAILED DESCRIPTION

Terms are used in conjunction with the present description which are also used in relevant publications and patents. However, it is to be noted that the use of these terms is merely to serve for better comprehension. The concepts disclosed herein and the scope of protection of the claims are not to be restricted in the interpretation by the specific selection of the terms. The disclosed devices and/or methods may be readily transferred to other term systems and/or technical fields. The terms are to be applied accordingly in other technical fields.

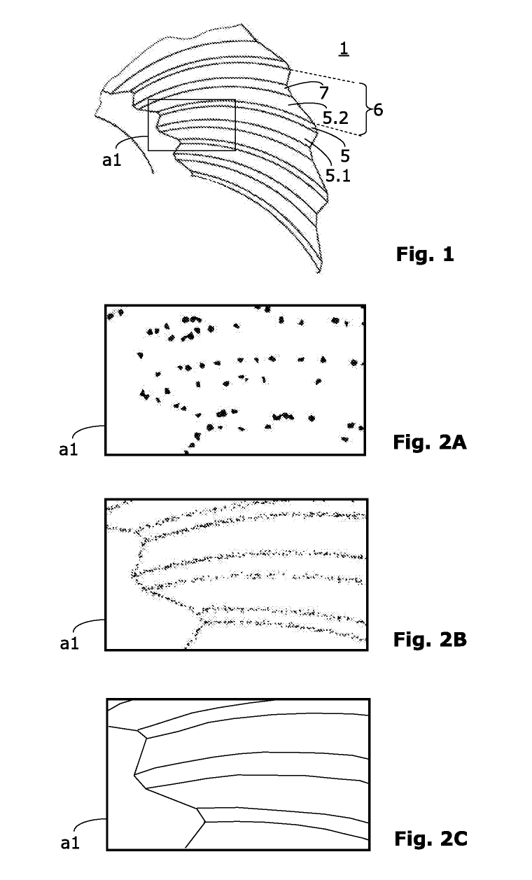

Certain principles will be explained based on the embodiments illustrated in FIGS. 1, and 2A to 2C.

FIG. 1 shows a schematic view of a section of a crown wheel workpiece 1. A tooth 5 of the crown wheel workpiece 1 is provided with a reference sign in FIG. 1. The reference sign 5 denotes here the tooth head of the tooth. The tooth 5 is delimited on one side by a concave tooth flank 5.1 and on the other side by a convex flank 5.2. The tooth base of a tooth gap 6 is provided with reference sign 7 above the convex tooth flank 5.2 here. The region of the tooth gap 6 is indicated by a curly bracket.

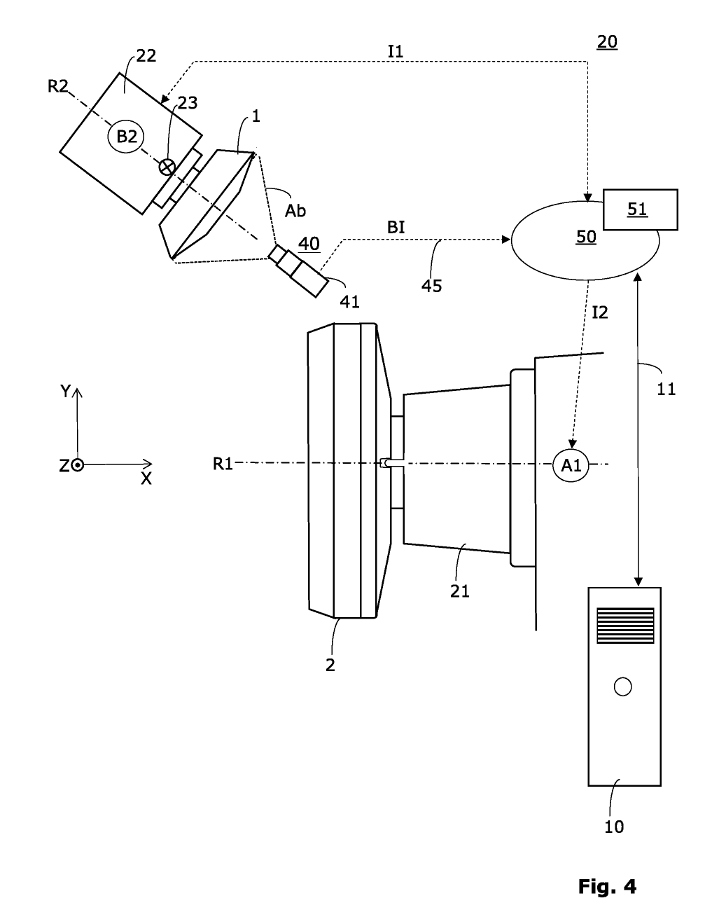

The present disclosure includes methods for machining toothed gearwheel workpieces, for example, the crown wheel workpiece 1 of the embodiment illustrated in FIG. 1. Before machining steps are carried out in a machine tool (for example, the grinding machine 20 of the embodiment illustrated in FIG. 4) on the gearwheel workpiece 1, the position of the gearwheel workpiece 1 in the machine tool 20 has to be determined. A sensor may be used for this purpose, as will be described hereafter.

An optical detector 40 may be used as the sensor to acquire image information BI of the gearwheel workpiece 1. If such an optical detector 40 cannot acquire an entire gearwheel workpiece 1 and the details thereof with sufficient resolution, a relative movement is executed between the detector 40 and the gearwheel workpiece 1 during the use of the optical detector 40, as described hereafter.

However, there are also configurations, for example, as shown in the embodiment illustrated in FIG. 4, in which an optical detector 40 can acquire an entire gearwheel workpiece 1 and the details thereof with sufficient resolution using one recording. A relative movement between the detector 40 and the gearwheel workpiece 1 is not absolutely necessary in this case.

Only a small image detail al through a rectangular viewing window is indicated in FIG. 1. The image detail al does not have to correspond to the imaging region of the detector 40.

An optical detector 40, as is used here, supplies image information BI. This image information BI may comprise a large number of pixels. A number of pixels are shown by way of example and schematically within the detail al illustrated in FIG. 2A. To be able to technically evaluate this point cloud of individual pixels, the image information BI is subjected to a computer ascertainment method.

When carrying out this ascertainment method, characteristic actual parameters cIG of the gearwheel workpiece 1 are ascertained based on the image information BI. The concept of the characteristic actual parameters cIG is used here to illustrate that these are parameters, values, or data which are characteristic of the gearwheel workpiece 1. Characteristic actual parameters cIG can be, for example, the angle position of the individual tooth flanks of the gearwheel workpiece 1.

In some embodiments, the characteristic actual parameters cIG are geometric and/or topographic information of the gearwheel workpiece 1.

The characteristic actual parameters cIG can comprise, for example, the topography. If, for example, 500 points of each tooth flank are acquired by means of the optical detector 40 and these (actual points) are jointly moved or adjusted by computer in space until the overall difference in relation to the target points of the tooth flank is minimal, a machine setting of the machine tool 20 for the least allowance can thus be ascertained therefrom.

To be able to ascertain technically usable, characteristic actual parameters cIG from a point cloud, as shown by way of example in the embodiment illustrated in FIG. 2A, an algorithm for edge detection can be used. This will be described in greater detail hereafter with reference to FIGS. 2B and 2C.

FIG. 2B shows the same detail al as FIG. 2A. The image information BI illustrated in FIG. 2A was processed using an algorithm for edge detection. In this case, pixels which lie on a line train or polygon train were emphasized more strongly, while other pixels (for example, individual image flaws) were suppressed. The human eye can also approximately recognize the edge progression of the gearwheel workpiece 1 in FIG. 2B.

The algorithm for edge detection is applied to obtain edge information from the discrete pixels of data illustrated in FIG. 2B. The data illustrated in FIG. 2C shows an exemplary result after application of the algorithm for edge detection. It can be seen that the pixels have been replaced by polygon trains.

The result can be further improved by further intermediate steps and/or post-processing steps. After the application of the algorithm for edge detection, for example, an algorithm can be used, which serves to approximate the individual sections of the polygon trains by curve sections. In this example, the slightly angled progression of the polygon trains is approximated as illustrated in FIG. 2C by a soft curve progression.

The corresponding methods for image processing are well-known and will not be described in greater detail here. There are numerous software products which specialize in converting image information into an edge representation and/or surface representation. Vectoring is mentioned here as an example, which prepares a vector family from pixels.

It is important that characteristic actual parameters cIG of the gearwheel workpiece 1 are available as the result of the ascertainment method. In the mentioned edge representation and/or surface representation, the edges and/or the surfaces are geometrically-mathematically defined in three-dimensional space. They are therefore provided as characteristic actual parameters cIG.

A CCD device 41 (CCD stands for charge coupled device) may be used as the optical detector 40.

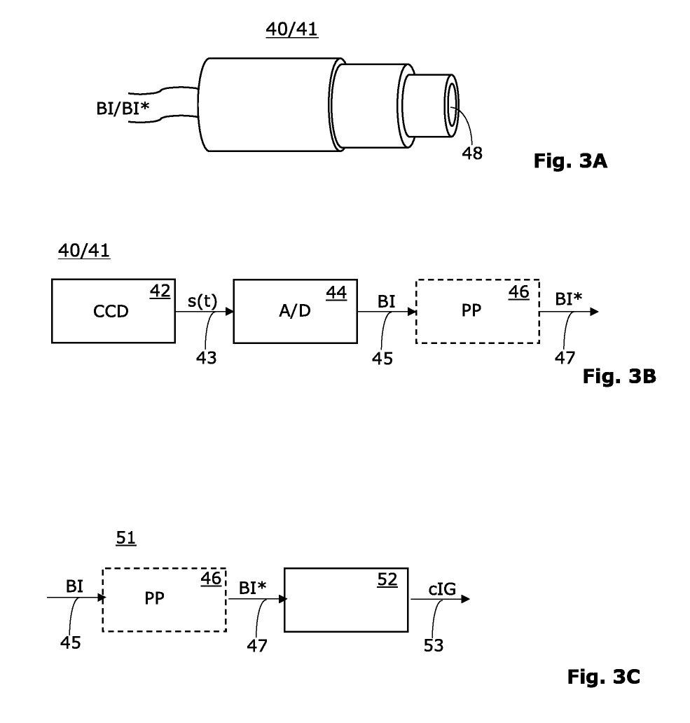

A CCD device 41 is shown by way of example and in perspective form in FIG. 3A. The CCD device 41 illustrated in FIG. 3A can contain the elements/circuit blocks illustrated in FIG. 3B in the interior. On one side or end, the CCD device 41 comprises an aperture, which can have therein an optical lens 48.

The elements/circuit blocks of a CCD device 41 are shown by way of example and in schematic form in FIG. 3B. This device 41 comprises in some embodiments a CCD element 42 (for example, a CCD chip), which provides an analog output signal s(t) at an output 43. This output signal s(t) can be converted, for example, by means of an analog-to-digital converter 44 into a digital signal. This digital signal contains or carries the image information which was acquired by the CCD element 42. The output 45 is therefore provided with the symbol BI.

The CCD device 41 can, in some embodiments, comprise one or more of the following elements/circuit blocks, additionally or alternatively to the elements/circuit blocks shown in the embodiment illustrated in FIG. 3B:

memory (for example, a memory chip),

a CPU (CPU stands for central processing unit),

a hardware interface (for example, for data transmission of the image information BI or BI* to a downstream processor (for example, as part of a computer or a controller 50)),

a power supply or a hardware interface for connection to a power supply,

an interface for controlling the CCD device 41 from the outside (for example, for control by means of a computer or a controller 50).

Optionally, a digital circuit can be provided for post-processing or processing of the image information BI, as indicated in the embodiment illustrated in FIG. 3B by the circuit block 46. In this optional case, the image information BI is provided as processed image information BI* at the output 47.

The circuit block 46 can also be designed in some embodiments, if present, for software-supported post-processing or processing of the image information BI.

The post-processing or processing of the image information BI can also in some embodiments be partially performed by the CCD device 41 and partially performed by a downstream processor (for example, as part of a computer or a controller 50).

The post-processing or processing of the image information BI can also be performed in some embodiments, however, by a downstream processor (for example, as part of a computer or a controller 50).

The processed image information BI* can thus differ, for example, from the image information BI in that one or more of the following measures may be applied in the post-processing or processing of the image information BI:

removing image flaws and/or noise,

adapting the brightness,

adapting the contrast,

adapting color information, if the CCD element 42 is a color-processing element,

data compression,

blanking out interfering artifacts, etc.

FIG. 3C shows a schematic block diagram of exemplary components of a module 51, which can be used in some embodiments to carry out an ascertainment method. The module 51 can be implemented, for example, in the CNC controller 50, as indicated in the embodiment illustrated in FIG. 4.

However, the module 51 can also be implemented in some embodiments at another location (for example, in the computer 10). The module 51 can also be, in some embodiments, an autonomous module, which comprises at least one processor, one program memory, and one working memory.

The module 51 has a communication connection, in some embodiments, to the CNC controller 50 and/or the computer 10 and/or the detector 40 of the machine tool 20.

An exemplary machine tool 20 comprises, as schematically shown in the embodiment illustrated in FIG. 4, a workpiece spindle 22, which is designed to accommodate a gearwheel workpiece 1 (in the form of a hypoid gearwheel illustrated in stylized form here). Moreover, it comprises a tool spindle 21 for accommodating a grinding tool 2 (in the form of a cup grinder here) and multiple drives (for example, A1, B2 and further drives not shown in this figure) for machining the gearwheel workpiece 1.

The tool 2 executes a rotation about the rotational axis R1 of the tool spindle 21 during the machining of the gearwheel workpiece 1. The corresponding axial drive is identified with A1. The gearwheel workpiece 1, depending on whether a single indexing method or a continuous indexing method is used, can be rotationally driven about the rotational axis R2, as indicated in FIG. 4 by the drive B2.

The tool 2 engages during the machining in the toothed gearwheel workpiece 1, in order to remove material. To accelerate the introduction of the tool 2 into tooth gaps of the gearwheel workpiece 1 (in comparison to previous methods) and/or to be able to execute the introduction without collision, the optical detector 40 (for example, in the form of a CCD device 41) is used.

Furthermore, the machine tool 20 can comprise a CNC controller 50, which is designed to control the movement sequences in the machine 20, as indicated by the control signals I1, I2. This controller 50 can control and drive, for example, the linear axes X, Y, Z (see FIG. 4) and the two rotational axes R1, R2.

Furthermore, the machine tool 20 can comprise a processor or be connected to a processor (for example, via a communication connection). A computer 10 is shown in FIG. 4, which comprises the processor and is especially designed (programmed) for the purpose of executing the disclosed methods or accompanying/assisting the execution of the methods. The processor (as part of a computer 10 here, for example) can have a communication connection to the machine 20 and/or the controller 50 in some embodiments, as indicated in FIG. 4 by the communication connection 11.

The computer 10 does not necessarily have to be a complete computer. In some embodiments, a computer module, a chip module, or a plug-in card having a processor or the like can also be used. The computer 10 can also be part of the controller 50, or the controller 50 can be part of the computer 10, in some embodiments.

In the embodiment illustrated in FIG. 4, a configuration is shown in which an optical detector in the form of a CCD device 41 is used, which is arranged coaxially to the rotational axis R2 of the workpiece spindle 22. The aperture of the CCD device 41 is located on the left here on the CCD device 41. The aperture here provides a view along the rotational axis R2 more or less from the front of the gearwheel workpiece 1. If the CCD device 41, as indicated in FIG. 4, has an imaging region al, which acquires all teeth of the gearwheel workpiece 1 using a single image recording, no relative movement of the gearwheel workpiece 1 in relation to the optical detector 40 is then required to acquire complete image information BI of the gearwheel workpiece 1.

As schematically indicated in FIG. 4, an output 45 of the CCD device 41 can supply the image information BI to the controller 50. In some embodiments, a direct or indirect communication connection can additionally or alternatively be provided between the CCD device 41 and a processor (for example, a computer 10), to supply the image information BI to the processor.

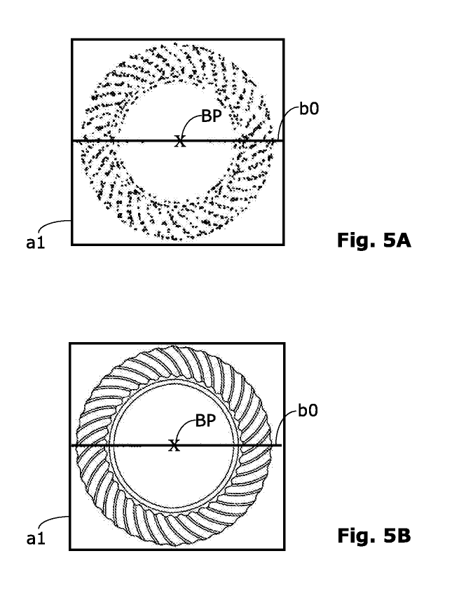

An optical detector 40, for example, the CCD device 41 here, supplies image information BI. This image information BI can comprise a large number of pixels. A number of pixels are shown by way of example and schematically inside a square detail al in FIG. 5A. The teeth of the hypoid gearwheel 1 can be recognized as indicated in in FIG. 5A, the image of which was acquired by a configuration according to FIG. 4, though other embodiments may be used to obtain such an image. To be able to technically evaluate these point clouds made of individual pixels, the image information BI was subjected to a computer ascertainment method.

FIG. 5B also shows the same detail al as shown in FIG. 5A. The image information BI shown in FIG. 5A was processed using an algorithm for edge detection and post-processed in a digital circuit 46. Pixels which lie on a line train or polygon train were emphasized more strongly in this case, while other pixels (for example, individual image flaws) were suppressed. The human eye can now also clearly recognize the edge progression of the gearwheel workpiece 1 from FIG. 5B.

A further exemplary aspect will be described based on FIGS. 5A and 5B. An image axis b0 can be overlaid or inserted here in some embodiments in an optical manner or by electronic means. Since this image axis b0, if present, is overlaid or inserted, it can be recognized more clearly than, for example, the tooth edges of the gearwheel workpiece 1.

If the optical detector 40 (the CCD device 41 here) has a fixed spatial relationship to a coordinate system of the machine tool 20, a fixed spatial relationship for this image axis b0 thus also results therefrom. This means the position of the image axis b0 is known in the three-dimensional space of the machine tool 20, or the controller 50 or the processor, respectively.

In the exemplary embodiment shown, this image axis b0 indicates the nine o'clock and the three o'clock positions. After carrying out the ascertainment method, for example, the characteristic actual parameters cIG of the gearwheel workpiece 1 can be related to the position of the image axis b0.

Proceeding from a reference point BP in three-dimensional space (for example, the passage point of the rotational axis R2 through the plane of the detail al here), an exact actual position (for example, as a specification in degrees of angle) can be associated with each tooth flank of the gearwheel workpiece 1.

In the case of an ideal gearwheel workpiece 1, i.e., in the case of a workpiece which corresponds to the target specification 1:1, upon the (computer) superposition or (computer) comparison of the actual positions of the tooth flanks to the target positions of the tooth flanks (these target positions of the tooth flanks can be provided, for example, from the computer design of the gearwheel workpiece 1), no deviations would result. This means all tooth flanks would lie exactly at the predetermined position.

However, since thermal deformations can occur during the previous gear cutting and/or subsequent hardening of the gearwheel workpiece 1, deviations typically result between the actual positions of the tooth flanks and the target positions of the tooth flanks.

The methods and/or devices disclosed herein enable various approaches for the finish machining, for example, of the tooth flanks of the gearwheel workpiece 1.

Thus, for example, by the application of a computer optimization method, an attempt can be made to make the actual position of each tooth flank congruent with the target positions of a corresponding tooth flank, such that all actual teeth only have a slight allowance in relation to the target teeth. In this case, relatively little material has to be removed at the tooth flanks using the tool 2 in the scope of the finish machining of the gearwheel workpiece 1 in the machine tool 20.

In practice, tolerances (for example, a tolerance window) are specified, since it will never be exactly possible to finish machine all tooth flanks so that they are exactly coincident with the target flanks after the finish machining.

With application of tolerances, it is possible in most cases to plan and execute the finish machining in the machine tool 20 so that all tooth flanks are in the tolerance window of the target flanks after the machining.

In view of the discussion of this example, one of ordinary skill in the art should understand that the characteristic actual parameters cIG ascertained optically can be used in some embodiments to optimize the steps of the finish machining.

In addition, in some embodiments, the characteristic actual parameters cIG ascertained optically can be used to move the tool 2 without collision into tooth gaps of the gearwheel workpiece 1 during the finish machining. If, for example, the concave tooth flank of the first tooth gap has to be finished machined by grinding, the machine tool 20 can thus rotate the gearwheel workpiece 1 about the rotational axis R2 via the controller 50 until the tool 2 can penetrate into the first tooth gap. It is to be noted in this case that the machine tool 20 comprises an angle decoder 23 in the region of the rotational axis R2, as schematically indicated in FIG. 4. The gearwheel workpiece 1 can be rotated into any angle position by the interaction of controller 50, drive B2, and angle decoder 23, before the tool 2 is used. The methods disclosed herein can be used in some embodiments to ascertain the angle position of the tooth flanks and/or tooth gaps and/or tooth heads, which have to be finish machined, to mention only a few possible uses.

As those skilled in the art should appreciate, various aspects of the present disclosure can be used to perform correction computations and then to carry out corresponding correction machining (called finish machining here) in the machine 20.

Likewise, various aspects of the present disclosure can be used to compute machine and/or tool settings based on optically ascertained items of information, which are then used during the finish machining.

The applicant reserves the right to incorporate features from the description and the patent claims, which includes parts of sentences from the description and the claims, in a claim and, in particular, to make them the subject matter of a new patent claim.

Terms like substantially, preferably and the like and indications that may possibly be understood to be inexact are to be understood to mean that a deviation from the normal value is possible.

Unless stated otherwise, terms such as, for example, “comprises,” “has,” “includes,” and all forms thereof, are considered open-ended, so as not to preclude additional elements and/or features.

Also unless stated otherwise, terms such as, for example, “a” and “one” are considered open-ended, and do not mean “only a” and “only one”, respectively.

Also, unless stated otherwise, the phrase “a first” does not, by itself, require that there also be a “second.”

Also unless stated otherwise, terms such as, for example, “in response to” and “based on” mean “in response at least to” and “based at least on,” respectively, so as not to preclude being responsive to and/or based on, more than one thing.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method comprising:
machining a toothed gearwheel workpiece using a machine tool including a sensor configured to acquire geometry information, a tool located on a tool spindle, and a workpiece spindle, wherein the gearwheel workpiece is located on the workpiece spindle, and the method includes the following steps:
a) acquiring, with a sensor including an optical detector, image information of the gearwheel workpiece without physical contact of the sensor therewith,
b) ascertaining at least one characteristic actual parameter of the gearwheel workpiece based on the image information,
c) machining at least one flank of the gearwheel workpiece using the tool, wherein said machining includes moving the tool into a tooth gap of the gearwheel workpiece without contact therewith using said at least one characteristic actual parameter, wherein the at least one flank is machined by relative movement of the tool and the gearwheel workpiece.

2. The method according to claim 1, wherein the optical detector is configured to acquire image information of at least a part of the gearwheel workpiece.

3. The method according to claim 2, further including, during the acquiring step, executing relative movement between the detector and the gearwheel workpiece to acquire image information of a region of the gearwheel workpiece larger than the imaging region of the detector.

4. The method according to claim 2, wherein the ascertaining step includes (a) converting the image information into one or more of edge or surface specifications, and (b) ascertaining the at least one characteristic actual parameter using the one or more of edge or surface specifications.

5. The method according to claim 4, wherein the converting step includes converting the image information into edge specifications using an algorithm adapted to detect edges.

6. The method according to claim 1, wherein the at least one characteristic actual parameter includes a position of one or more of at least one tooth head, at least one tooth flank, or at least one tooth gap, and the ascertaining step includes determining said position.

7. The method according to claim 1, wherein the optical detector includes a CCD detector comprising a group of detector elements configured to acquire said image information as pixels.

8. A machine tool for machining a gearwheel workpiece, comprising:
a tool spindle configured for fastening a tool thereto;
a workpiece spindle configured for fastening a gearwheel workpiece thereto; and
a CNC controller;
wherein the machine tool defines multiple axes configured for use for CNC-controlled machining of the gearwheel workpiece using the tool, and further includes
an optical detector adapted to acquire image information of a gearwheel workpiece, and
a module configured to ascertain at least one characteristic actual parameter of a gearwheel workpiece based on such image information.

9. The machine tool according to claim 8, wherein the machine tool is configured to execute a relative movement between the detector and the gearwheel workpiece while the detector acquires image information of the gearwheel workpiece.

10. The machine tool according to claim 8, wherein the module is configured
to acquire such image information, and
to ascertain such at least one characteristic actual parameter from one or more of edge or surface specifications derived from such image information.

11. The machine tool according to claim 8, wherein the module is configured to process such image information for edge detection by using an algorithm.

12. The machine tool according to claim 8, wherein the detector includes a CCD detector comprising a group of detector elements configured to acquire such image information as pixels.
